(19) United States
(12) Patent Application Publication
(10) Pub. No.: US 2018/0113437 A1
(43) Pub. Date: Apr. 26, 2018

(54) Validation of Three-Dimensional Fabricated Object

(71) Applicant: Microsoft Technology Licensing, LLC, Redmond, WA (US)

(72) Inventors: Lakshmi Narayana Mummidi, Bellevue, WA (US); Parmjeet Singh, Bellevue, WA (US)

(73) Assignee: Microsoft Technology Licensing, LLC, Redmond, WA (US)

(21) Appl. No.: 15/299,759

(22) Filed: Oct. 21, 2016

(51) Int. Cl. G05B 19/4099; B29C 67/00; B33Y 50/02; B33Y 30/00

(52) U.S. Cl. CPC G05B 19/4099; B29C 67/0088; G05B 2219/49007; B33Y 30/00; G05B 2219/35134; B33Y 50/02

(57) ABSTRACT

Described herein is a three-dimensional object validation system in which a source model generation component is configured to receive information about a three-dimensional object to be fabricated (e.g., 3MF file) and, based upon the received information, generate a source model of the three-dimensional object to be fabricated. A fabricated model generation component is configured to receive information about a fabricated three-dimensional object from one or more observation components and, based upon the received information, generate a fabricated model of the three-dimensional object of the fabricated three-dimensional object. A comparison component is configured to compare the generated fabricated model to the generated source model to determine whether a discrepancy exists between the generated fabricated model and the generated source model, and, when the discrepancy is determined to exist, take an action such as halting a fabrication process.

### BACKGROUND

Three-dimensional objects can be fabricated by various ways including printing and additive process(es). Further, materials consumed can vary by printer or additive process. In order to generate three-dimensional objects, a representation of the three-dimensional object to be fabricated (e.g., 3MF file) is segmented along the z-axis by a renderer into slices. These slices are then successively utilized to fabricate the three-dimensional object.

### SUMMARY

Described herein is a three-dimensional object validation system comprising a computer comprising a processor and a memory. The memory comprises a source model generation component configured to receive information about a three-dimensional object to be fabricated and, based upon the received information, generate a source model of the three-dimensional object to be fabricated.

The memory further comprises a fabricated model generation component configured to receive information about a fabricated three-dimensional object from one or more observation components and, based upon the received information, generate a fabricated model of the three-dimensional object of the fabricated three-dimensional object. The memory further comprises a comparison component configured to compare the generated fabricated model to the generated source model to determine whether a discrepancy exists between the generated fabricated model and the generated source model, and, when the discrepancy is determined to exist, take an action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a three-dimensional object validation system.

FIG. 2 is a functional block diagram of a three-dimensional object validation system.

FIG. 3 is a functional block diagram of a three-dimensional object validation system.

FIG. 4 illustrates an exemplary user interface illustrating an information panel and an action area.

FIG. 5 illustrates an exemplary methodology of a method of validating a three-dimensional object.

FIG. 6 illustrates an exemplary methodology of a method of validating a three-dimensional object.

FIG. 7 illustrates an exemplary methodology of a method of validating a three-dimensional object.

FIG. 8 is a functional block diagram that illustrates an exemplary computing system.

### DETAILED DESCRIPTION

Various technologies pertaining to validation of at least a portion of a three-dimensional object (e.g., during printing) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding validation of at least a portion of a three-dimensional object. What follows are one or more exemplary systems and methods.

Aspects of the subject disclosure pertain to the technical problem of validating at least a portion of a three-dimensional object (e.g., during printing). For example, during printing, quality of a three-dimensional object can be less than satisfactory (e.g., due to printer base misalignment, material clogging a jet, discrepancy in printer driver(s) and/or software, etc.)

The technical features associated with addressing this problem involve using input from observation component(s) such as sensor(s), camera(s) and the like to generate a fabricated model of the three-dimensional object being fabricated (e.g., printed). The fabricated model is then compared with a source model to determine whether discrepancy(ies) exist (e.g., greater than a threshold amount). When discrepancy(ies) are determined to exist, action(s) can be taken, for example, to mitigate waste of material and/or wasted utilization of a three-dimensional printer. Accordingly, aspects of these technical features exhibit technical effects of more efficiently and effectively fabricating three-dimensional objects, for example, reducing wasted material.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

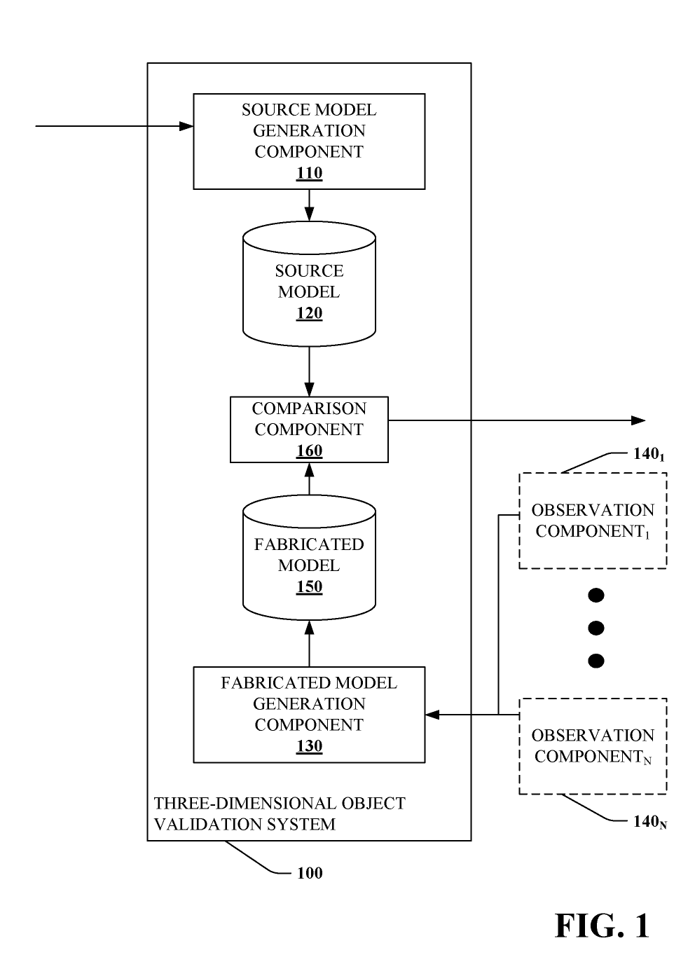

Referring to FIG. 1, a three-dimensional object validation system 100 is illustrated. The system 100 can be used to validate a three-dimensional object during and/or after fabrication, for example, to reduce material waste and/or to increase quality control.

The system 100 includes a source model generation component 110 that receives information (e.g., a file) about a three-dimensional object to be fabricated (e.g., printed). In one embodiment, the information comprises a 3D Manufacturing Format file (e.g., 3MF file). The 3MF format describes a set of conventions for the use of XML and other widely available technologies to describe content and appearance of three-dimensional model(s). For example, a 3MF file can include a list of vertices, triangles and meshes for fabricating the three-dimensional object. While the use of 3MF file(s) is discussed herein, those skilled in the art will recognize that the subject disclosure is not limited to 3MF files and that the subject disclosure can be utilized with any suitable representation of three-dimensional object(s) including, for example, object (OBJ) files, stereo lithography (STL) files, virtual reality modeling language (VRML) files, X3G files, polygon (PLY) files and/or filmbox (FBX) files. Based upon the received information about the three-dimensional object to be fabricated (e.g., 3MF file), the source model generation component 110 generates a source model 120 of the three-dimensional object to be fabricated.

Once fabrication (e.g., printing) has commenced, information about the fabricated three-dimensional object can be received by a fabricated model generator component 130 from one or more observation components 140 (e.g., camera(s), sensor(s) and the like). In one embodiment, the one or more observation components 140 comprise a device to receive video/pictures such as Microsoft Kinect® depth camera and the like. In one embodiment, the one or more observation components 140 can comprise precision sensor(s), z-index sensor(s) and/or depth sensor(s) employing x-ray beam(s), laser, ultrasound and the like. In one embodiment, the one or more observation component 140 can comprise digital camera(s), three-dimensional camera(s), movement detector(s), microphone(s) and the like.

In one embodiment, the one or more observation components 140 are integral to a fabrication apparatus such as a three-dimensional printer. In one embodiment, the one or more observation components 140 are not integral to the fabrication apparatus. Instead, the one or more observation component 140 are physically located in proximity to the three-dimensional object being fabricated. For example, the one or more observation components 140 can be arranged to obtain information about the three-dimensional object being fabricated without interfering with the fabrication process.

Based on the information about the fabricated three-dimensional object received from the one or more observation components 140, the fabricated model generator component 130 can generate a fabricated model 150 of the fabricated three-dimensional object. In one embodiment, the fabricated model generator component 130 can stitch together images from a plurality of observation components 140 (e.g., cameras) using rich image processing and three-dimensional model creation algorithm(s) to generate the fabricated model 150. In one embodiment, information from a plurality of digital cameras is used to generate a 360 degree view of the fabricated three-dimensional object which is then used to generate the fabricated model 150.

A comparison component 160 can compare the generated fabricated model 150 to the generated source model 120 to determine whether discrepancy(ies) exist between the two models 150, 120. In one embodiment, the comparison component 160 receives information about the fabrication apparatus (e.g., manufacturer, serial number, software version identifier and the like). Based upon the information about the fabrication apparatus and an amount of time spent fabricating the three-dimensional object, the comparison component 160 can determine a portion of the generated source model 120 which the fabrication apparatus is expected to have fabricated in the amount of time. The comparison component 160 can then compare the portion of the generated source model 120 to the generated fabricated model 150 to determine whether discrepancy(ies) exist between the two models.

Discrepancy(ies) can include one or more related to the fabricated three dimensional object: accuracy, quality, thickness, alignment, measurement in one or more axes, deformation(s), quality of surface area (e.g., gaps and misalignment) and the like. For example, during fabrication, a deviation from an expected height of the object along the z-axis (e.g., axis of successive fabrication) can be indicative of gap(s) and/or inadequate/insufficient bonding of layers.

In one embodiment, determination that discrepancy(ies) exist is based on predictive modeling of historical usage of the particular fabrication apparatus and/or similar fabrication apparatuses. For example, a cloud-based service can aggregate information regarding usage of a particular type of fabrication apparatus, material used, configuration setting(s) of fabrication apparatuses and the like to determine that discrepancy(ies) determined based upon the information received from the observation component 140 frequently yield poor quality fabricated three-dimensional objects, resulting in waste materials and resources. By determining that the discrepancy(ies) exist with respect to the particular three-dimensional object being fabricated, such wasted materials and/or resources can be mitigated.

In one embodiment, when discrepancy(ies) exist, an action is taken when one or more particular discrepancies are determined to exist. In one embodiment, when discrepancy(ies) exist, action is taken when the discrepancy(ies) are greater than a threshold amount. For example, the threshold amount can be user selectable such as acceptable deviation in one or more of the axes.

In one embodiment, based upon a determined discrepancy, the comparison component 160 can halt the fabrication process, for example, to mitigate waste of fabrication material and/or utilization of the fabrication apparatus. In one embodiment, based upon a determined discrepancy, the comparison component 160 can alert a user of the discrepancy. In one example, a type of alert can be based upon a user selection. The alert can include an email message, a telephone message, a text message and the like alerting the user of the existence of a discrepancy.

In one embodiment, a type of alert can be based upon a hierarchical ranking of potential discrepancies. For example, for a discrepancy in one axis of greater than a first threshold but less than a second threshold, a notification can be displayed to the user. However, for a discrepancy equal to or greater than the second threshold, the comparison component 160 can halt the process and alert the user via one or more communication modalities.

In one embodiment, the action taken by the comparison component 160 can include an audible signal and/or a visual signal to the user. In one embodiment, information regarding the determined discrepancy(ies) can be presented to the user, for example, via a display. In one embodiment, information regarding potential cause(s) of the discrepancy(ies) can be provided to the user. For example, information regarding potential cause(s) (e.g., printer not properly configured and/or aligned, lack of needed support, printer software issue(s), model input issue(s) and the like) can be determined from a data store of potential causes stored locally or available via a network connection (e.g., cloud-based accessible via the Internet).

In one embodiment, identified solution(s) associated with the determined discrepancy(ies) can be provided to the user. For example, adjustment(s) to the printer alignment, support needed, material alignment, correct z-index and the like.

In one embodiment, the system 100 can provide information regarding corrective action(s) can be presented to the user, for example, via the display. For example, corrective actions can include printer alignment, printer setting(s), support needed and the like.

Based upon the action taken and/or information presented by the comparison component 160, the user can make a determination of how to proceed. For example, the user can stop the fabrication process and restart, the user can choose to ignore the discrepancy(ies) and proceed with the fabrication process and/or the user can make adjustments to the fabrication process and then proceed with the adjusted fabrication process.

The comparison by the comparison component 160 can occur once or more during a fabrication process. In one embodiment, a frequency of comparison is based upon user input, for example, based upon a period of time and/or a point in fabrication (e.g., particular number of slice(s) fabricated). In one embodiment, comparison is performed during fabrication. In one embodiment, comparison is perform after fabrication has substantially been completed, for example, as quality control.

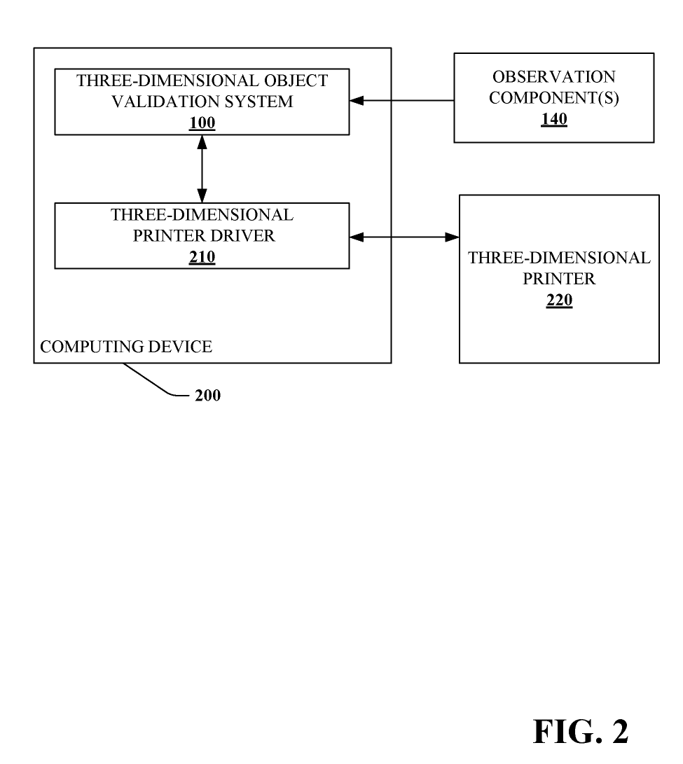

Turning briefly to FIG. 2, in one embodiment, the three-dimensional object validation system 100 can be a component of a computing device 200. The computing device 200 can further include a three-dimensional printer driver 210 that includes a renderer that divides a received representation of a three-dimensional object to be printed into slices. The three-dimensional printer driver 210 further provides instructions to a three-dimensional printer 220 for fabricating the three-dimensional object. Observation component(s) 140 can provide information to the three-dimensional object validation system 100, as described above.

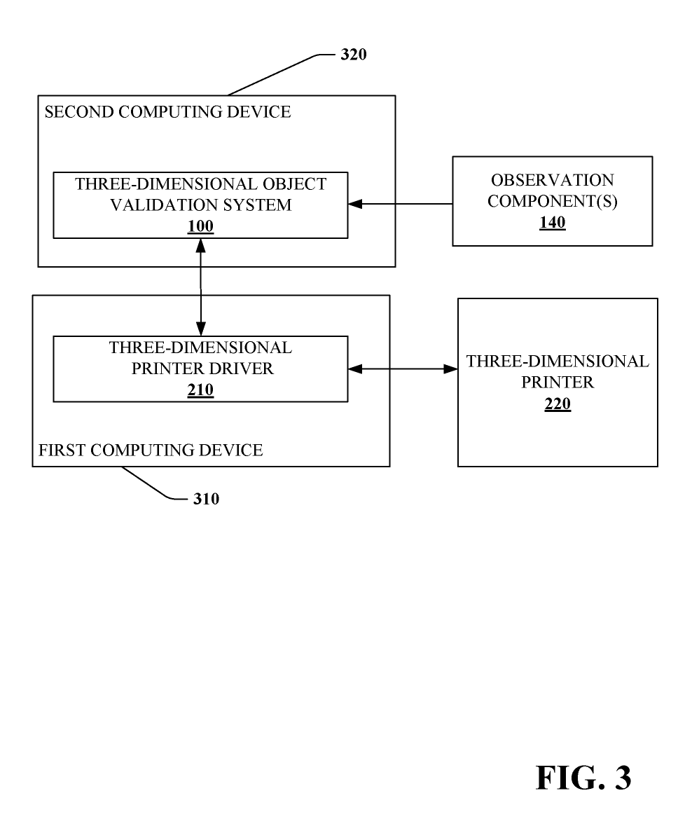

Referring next to FIG. 3, in one embodiment, the three-dimensional printer driver 210 is hosted on a first computing device 310 with the three-dimensional object validation system 100 hosted on a second computing device 320. In one embodiment, the second computing device 320 is physically local to the first computing device 310. In one embodiment, the second computing device 320 is remote to the first computing device 310 and coupled communicatively via a network such as the Internet. For example, the three-dimensional objection validation system 100 can be cloud-based.

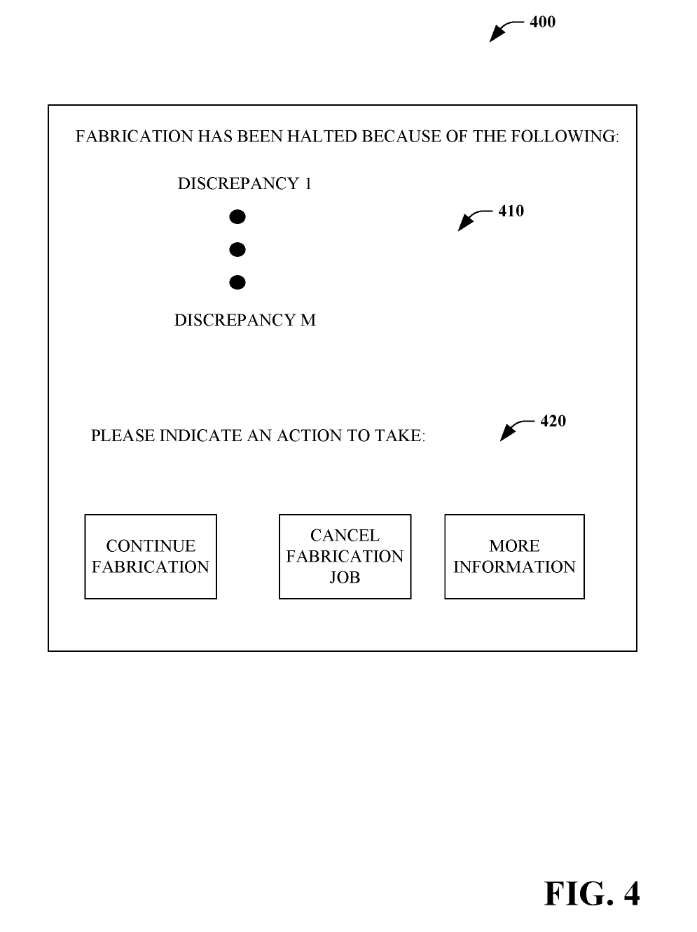

Turning to FIG. 4, an exemplary user interface 400 is illustrated. The user interface 400 includes an information panel 410 that provides information to a user indicating that fabrication has been halted because of discrepancy(ies) determined between a source model and a fabricated model, as discussed above. The user interface 400 further includes an action area 420 that allows for the user to select from one or more actions to be taken in response to the determined discrepancy(ies).

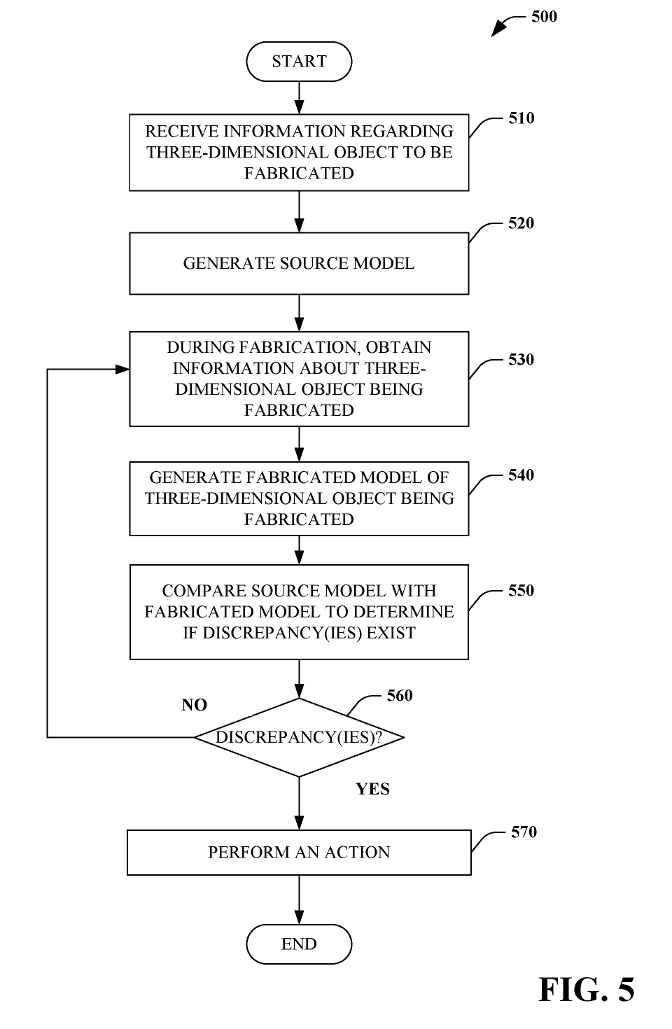

FIGS. 5, 6 and 7 illustrate exemplary methodologies relating to validating a three-dimensional object. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 5, a method of validating a three-dimensional object 500 is illustrated. For example, the method 500 can be used to validate a three-dimensional object during and/or after fabrication.

At 510, information regarding a three-dimensional object to be fabricated is received. For example, the information can comprises a file identifying vertices, triangles and meshes that define the three-dimensional object. In one embodiment, the information can comprise a 3MF file.

At 520, a source model is generated based upon the information regarding the three-dimensional object to be fabricated. At 530, during fabrication of the three-dimensional object, information about the object being fabricated is obtained. The information can be obtained from one or more observation components 140, as discussed above. In one embodiment, the observation components 140 can comprise a Microsoft Kinect® depth camera. In one embodiment, the observation components 140 can comprise a plurality of digital cameras.

At 540, a model of the object being fabricated is generated (e.g., fabricated model). In one embodiment, images from a plurality of observation components 140 (e.g., cameras) can be stitched together using rich image processing and three-dimensional model creation algorithm(s) to generate the fabricated model. In one embodiment, information from a plurality of digital cameras is used to generate a 360 degree view of the fabricated three-dimensional object which is then used to generated the fabricated model.

At 550, the source model is compared with the fabricated model to determine whether discrepancy(ies) exist. In one embodiment, the comparison can be based upon received information about a fabrication apparatus (e.g., manufacturer, serial number, software version identifier and the like). Based upon the information about the fabrication apparatus and an amount of time spent fabricating the three-dimensional object, a portion of the generated source model which the fabrication apparatus is expected to have fabricated in the amount of time can be determined. Comparison can then be made between the portion of the generated source model to the generated fabricated model 150 to determine whether discrepancy(ies) exist between the two models.

As noted discrepancy(ies) can include one or more related to the fabricated three dimensional object: accuracy, quality, thickness, alignment, measurement in one or more axes, deformation(s), quality of surface area (e.g., gaps and misalignment) and the like. For example, during fabrication, a deviation from an expected height of the object along the z-axis (e.g., axis of successive fabrication) can be indicative of gap(s) and/or inadequate/insufficient bonding of layers.

At 560, a determination is made as to whether discrepancy(ies) exist. If the determination at 560 is NO, and the fabrication processing has not been completed, processing continues at 530. If the determination at 560 is YES, at 570, an action is performed.

In one embodiment, the action performed is based upon user selection. In one embodiment, the action performed is determined based upon the determined discrepancy. In one embodiment, the action performed comprises halting the fabrication process until a user input is received. In one embodiment, the action performed comprises providing information regarding the determined discrepancy(ies) to the user. In one embodiment, the action performed comprises providing information regarding potential source(s) of the determined discrepancy(ies) to the user.

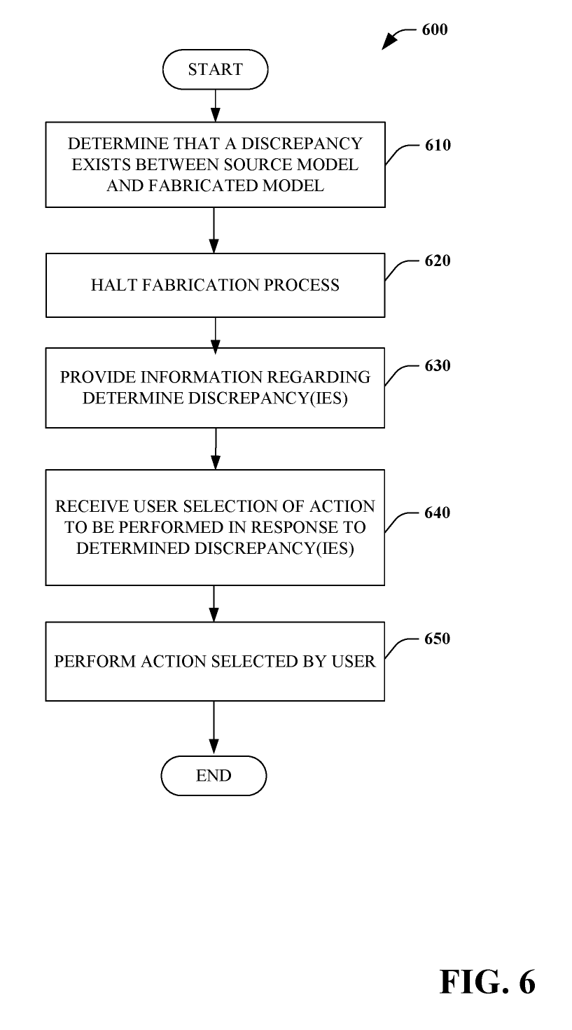

Turning to FIG. 6, a method of validating a three-dimensional object 600 is illustrated. At 610, a discrepancy is determined to exist between a source model of a three-dimensional object to be fabricated and a model of three-dimensional object as fabricated (e.g., fabricated model).

At 620, the fabrication process is halted. At 630, information regarding the determined discrepancy(ies) is provided to the user. In one embodiment, information regarding the determined discrepancy(ies) displayed to the user. In one embodiment, a text message is sent to the user. In one embodiment, a telephone call is initiated to the user. In one embodiment, an email is sent to the user.

At 640, a user selection of an action to be performed in response to the determined discrepancy(ies) is received. At 650, the action selected by the user is performed.

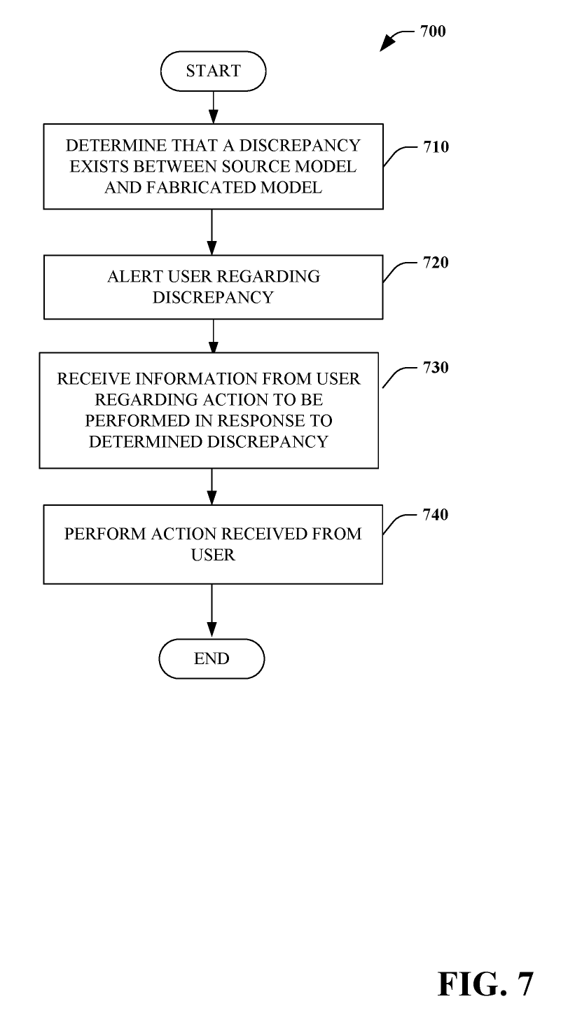

Next, referring to FIG. 7, a method of validating a three-dimensional object 700 is illustrated. At 710, a discrepancy is determined to exist between a source model of a three-dimensional object to be fabricated and a model of three-dimensional object as fabricated (e.g., fabricated model).

At 720, a user is alerted regarding the determined discrepancy. At 730, information regarding an action to be performed in response to the determined discrepancy is received from the user. At 740, the action received from the user is performed.

Described herein is a three-dimensional object validation system including a computer comprising a processor and a memory. The memory includes a source model generation component configured to receive information about a three-dimensional object to be fabricated and, based upon the received information, generate a source model of the three-dimensional object to be fabricated. The memory further includes a fabricated model generation component configured to receive information about a fabricated three-dimensional object from one or more observation components and, based upon the received information, generate a fabricated model of the three-dimensional object of the fabricated three-dimensional object. The memory also includes a comparison component configured to compare the generated fabricated model to the generated source model to determine whether a discrepancy exists between the generated fabricated model and the generated source model, and, when the discrepancy is determined to exist, take an action. The system further includes the observation component, wherein the observation component comprises a sensor.

The system can include wherein the information about the three-dimensional object to be fabricated comprises a 3D Manufacturing Format (3MF) file, an object (OBJ) file, a stereo lithography (STL) file, a virtual reality modeling language (VRML) file, an X3G file, a polygon (PLY) file or a filmbox (FBX) file.

The system can include wherein the information about the three-dimensional object to be fabricated comprises a file. The system can further include wherein the fabricated model generation component receives information about the fabricated three-dimensional object during fabrication of the three-dimensional object. The system can include wherein the action taken is based upon the determined discrepancy.

The system can include wherein the fabricated model generation component stitches together a plurality of images from the one or more observation components using image processing and a three-dimensional model creation algorithm. The system can further include wherein the one or more observation components comprise a depth camera.

The system can include wherein the one or more observation component comprises at least one of a digital camera, a three-dimensional camera, a movement detector, a microphone, a precision sensor, a z-index sensor and a depth sensor. The system can further include wherein the action comprises at least one of halting a fabrication process, providing an audible signal the user, providing a visual signal to the user, sending an e-mail message to the user, sending a telephone message to the user or sending a text message to the user. The system can further include wherein the action taken is based upon a receive user input selecting one of a plurality of actions.

The system can include wherein the discrepancy is based upon at least one accuracy, quality, thickness, alignment, measurement in one or more axes, a deformation. The system can further include wherein the action comprises providing information a potential cause of the determined discrepancy to the user.

Described herein is a method of validating a three-dimensional object including generating a source model based upon received information regarding a three-dimensional object to be fabricated. The method can further include during fabrication of the three-dimensional object, obtaining information about the three-dimensional object being fabricated. The method can include generating a fabricated model of the three-dimensional object being fabricated based upon the obtained information. The method can further include comparing the source model with the fabricated model to determine whether a discrepancy exists between the source model and the fabricated model, and, if the discrepancy exists, performing an action. The method further includes wherein the obtained information about the three-dimensional object being fabricated is received from a sensor.

The method can include wherein the received information regarding the three-dimensional object to be fabricated comprises a 3D Manufacturing Format (3MF) file , an object (OBJ) file, a stereo lithography (STL) file, a virtual reality modeling language (VRML) file, an X3G file, a polygon (PLY) file or a filmbox (FBX) file. The method can further include wherein the obtained information about the three-dimensional object being fabricated is further received from a depth camera.

The method can include wherein the determine whether the discrepancy exists between the source model and the fabricated model is based upon a user-specified threshold. The method can further include wherein the action performed is based upon the determined discrepancy.

Described herein is a computer storage media storing computer-readable instructions that when executed cause a computing device to generate a source model based upon received information regarding a three-dimensional object to be fabricated. The computer storage media can further store computer-readable instructions that when executed cause the computing device to during fabrication of the three-dimensional object, obtain information about the three-dimensional object being fabricated. The computer storage media can further store computer-readable instructions that when executed cause the computing device to generate a fabricated model of the three-dimensional object being fabricated based upon the obtained information. The computer storage media can further store computer-readable instructions that when executed cause the computing device to compare the source model with the fabricated model to determine whether a discrepancy exists between the source model and the fabricated model, and, when the discrepancy exists, perform an action comprising halting the fabrication of the three-dimensional object.

The computer storage media can further include wherein the received information regarding the three-dimensional object to be fabricated comprises a 3D Manufacturing Format (3MF) file, an object (OBJ) file, a stereo lithography (STL) file, a virtual reality modeling language (VRML) file, an X3G file, a polygon (PLY) file or a filmbox (FBX) file. The computer storage media can further include wherein the obtain information about the three-dimensional object being fabricated is received from at least one of a depth camera or a sensor.

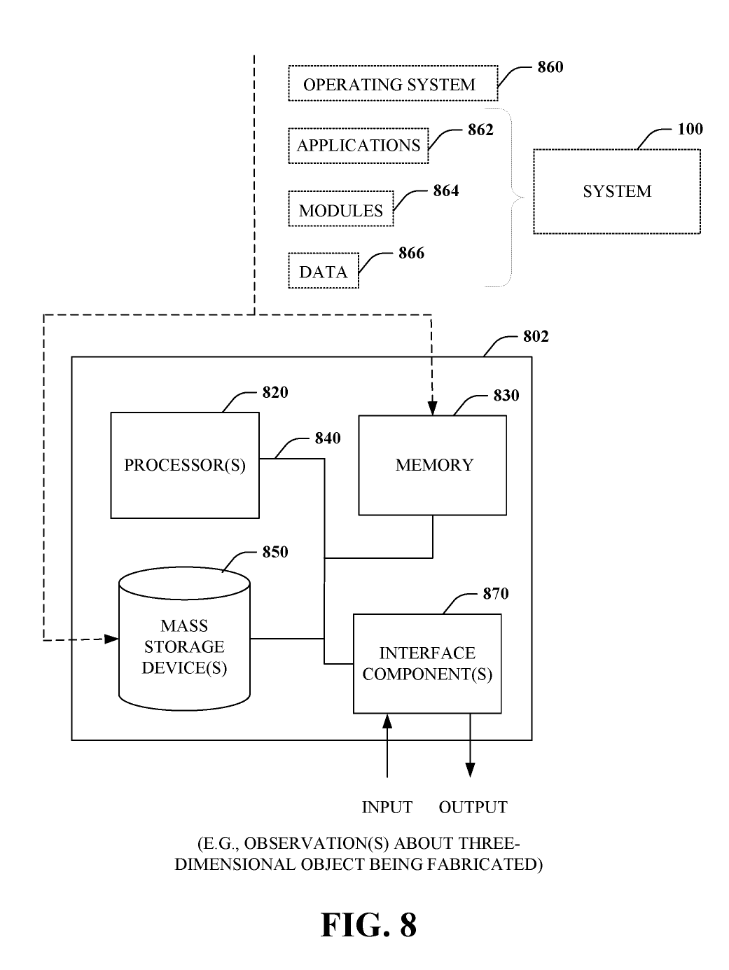

With reference to FIG. 8, illustrated is an example general-purpose computer or computing device 802 (e.g., desktop, laptop, tablet, watch, server, hand-held, programmable consumer or industrial electronics, set-top box, game system, compute node, etc.). For instance, the computing device 802 may be used in a three-dimensional object validation system.

The computer 802 includes one or more processor(s) 820, memory 830, system bus 840, mass storage device(s) 850, and one or more interface components 870. The system bus 840 communicatively couples at least the above system constituents. However, it is to be appreciated that in its simplest form the computer 802 can include one or more processors 820 coupled to memory 830 that execute various computer executable actions, instructions, and or components stored in memory 830. The instructions may be, for instance, instructions for implementing functionality described as being carried out by one or more components discussed above or instructions for implementing one or more of the methods described above.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 820 can be a graphics processor.

The computer 802 can include or otherwise interact with a variety of computer-readable media to facilitate control of the computer 802 to implement one or more aspects of the claimed subject matter. The computer-readable media can be any available media that can be accessed by the computer 802 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 802. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 830 and mass storage device(s) 850 are examples of computer-readable storage media. Depending on the exact configuration and type of computing device, memory 830 may be volatile (e.g., RAM), non-volatile (e.g., ROM, flash memory, etc.) or some combination of the two. By way of example, the basic input/output system (BIOS), including basic routines to transfer information between elements within the computer 802, such as during start-up, can be stored in nonvolatile memory, while volatile memory can act as external cache memory to facilitate processing by the processor(s) 820, among other things.

Mass storage device(s) 850 includes removable/non-removable, volatile/non-volatile computer storage media for storage of large amounts of data relative to the memory 830. For example, mass storage device(s) 850 includes, but is not limited to, one or more devices such as a magnetic or optical disk drive, floppy disk drive, flash memory, solid-state drive, or memory stick.

Memory 830 and mass storage device(s) 850 can include, or have stored therein, operating system 860, one or more applications 862, one or more program modules 864, and data 866. The operating system 860 acts to control and allocate resources of the computer 802. Applications 862 include one or both of system and application software and can exploit management of resources by the operating system 860 through program modules 864 and data 866 stored in memory 830 and/or mass storage device (s) 850 to perform one or more actions. Accordingly, applications 862 can turn a general-purpose computer 802 into a specialized machine in accordance with the logic provided thereby. In one example, application 862 includes key service component 160.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 862, and include one or more modules 864 and data 866 stored in memory and/or mass storage device(s) 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 802 also includes one or more interface components 870 that are communicatively coupled to the system bus 840 and facilitate interaction with the computer 802. By way of example, the interface component 870 can be a port (e.g., serial, parallel, PCMCIA, USB, FireWire, etc.) or an interface card (e.g., sound, video, etc.) or the like. In one example implementation, the interface component 870 can be embodied as a user input/output interface to enable a user to enter commands and information into the computer 802, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 870 can be embodied as an output peripheral interface to supply output to displays (e.g., LCD, LED, plasma, etc.), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A three-dimensional object validation system, comprising:
a computer comprising a processor and a memory, the memory comprising:
a source model generation component configured to receive information about a three-dimensional object to be fabricated and, based upon the received information, generate a source model of the three-dimensional object to be fabricated;
a fabricated model generation component configured to receive information about a fabricated three-dimensional object from one or more observation components and, based upon the received information, generate a fabricated model of the three-dimensional object of the fabricated three-dimensional object; and
a comparison component configured to compare the generated fabricated model to the generated source model to determine whether a discrepancy exists between the generated fabricated model and the generated source model, and, when the discrepancy is determined to exist, take an action; and
the observation component, wherein the observation component comprises a sensor.

2. The system of claim 1, wherein the information about the three-dimensional object to be fabricated comprises a 3D Manufacturing Format (3MF) file, an object (OBJ) file, a stereo lithography (STL) file, a virtual reality modeling language (VRML) file, an X3G file, a polygon (PLY) file or a filmbox (FBX) file.

3. The system of claim 1, wherein the information about the three-dimensional object to be fabricated comprises a file.

4. The system of claim 1, wherein the fabricated model generation component receives information about the fabricated three-dimensional object during fabrication of the three-dimensional object.

5. The system of claim 1, wherein the action taken is based upon the determined discrepancy.

6. The system of claim 1, wherein the fabricated model generation component stitches together a plurality of images from the one or more observation components using image processing and a three-dimensional model creation algorithm.

7. The system of claim 1, wherein the one or more observation components comprise a depth camera.

8. The system of claim 1, wherein the one or more observation component comprises at least one of a digital camera, a three-dimensional camera, a movement detector, a microphone, a precision sensor, a z-index sensor and a depth sensor.

9. The system of claim 1, wherein the action comprises at least one of halting a fabrication process, providing an audible signal the user, providing a visual signal to the user, sending an e-mail message to the user, sending a telephone message to the user or sending a text message to the user.

10. The system of claim 1, wherein the action taken is based upon a receive user input selecting one of a plurality of actions.

11. The system of claim 1, wherein the discrepancy is based upon at least one accuracy, quality, thickness, alignment, measurement in one or more axes, a deformation.

12. The system of claim 1, wherein the action comprises providing information a potential cause of the determined discrepancy to the user.

13. A method of validating a three-dimensional object, comprising:
generating a source model based upon received information regarding a three-dimensional object to be fabricated;
during fabrication of the three-dimensional object, obtaining information about the three-dimensional object being fabricated, wherein the obtained information about the three-dimensional object being fabricated is received from a sensor;
generating a fabricated model of the three-dimensional object being fabricated based upon the obtained information;
comparing the source model with the fabricated model to determine whether a discrepancy exists between the source model and the fabricated model; and, if the discrepancy exists, performing an action.

14. The method of claim 13, wherein the received information regarding the three-dimensional object to be fabricated comprises a 3D Manufacturing Format (3MF) file, an object (OBJ) file, a stereo lithography (STL) file, a virtual reality modeling language (VRML) file, an X3G file, a polygon (PLY) file or a filmbox (FBX) file.

15. The method of claim 13, wherein the obtained information about the three-dimensional object being fabricated is further received from a depth camera.

16. The method of claim 13, wherein the determine whether the discrepancy exists between the source model and the fabricated model is based upon a user-specified threshold.

17. The method of claim 13, wherein the action performed is based upon the determined discrepancy.

18. A computer storage media storing computer-readable instructions that when executed cause a computing device to:
generate a source model based upon received information regarding a three-dimensional object to be fabricated;
during fabrication of the three-dimensional object, obtain information about the three-dimensional object being fabricated;
generate a fabricated model of the three-dimensional object being fabricated based upon the obtained information;
compare the source model with the fabricated model to determine whether a discrepancy exists between the source model and the fabricated model; and,
when the discrepancy exists, perform an action comprising halting the fabrication of the three-dimensional object.

19. The computer storage media of claim 18, wherein the received information regarding the three-dimensional object to be fabricated comprises a 3D Manufacturing Format (3MF) file, an object (OBJ) file, a stereo lithography (STL) file, a virtual reality modeling language (VRML) file, an X3G file, a polygon (PLY) file or a filmbox (FBX) file.

20. The computer storage media of claim 18, wherein the obtain information about the three-dimensional object being fabricated is received from at least one of a depth camera or a sensor.
